(19) United States
(12) Patent Application Publication
(10) Pub. No.: US 2025/0284175 A1
(43) Pub. Date: Sep. 11, 2025

(54) WAVELENGTH CONVERSION APPARATUS AND WAVELENGTH CONVERSION METHOD

(71) Applicant: Lasertec Corporation, Yokohama (JP)

(72) Inventors: Jun SAKUMA, Yokohama-shi (JP); Ryotaro MORI, Yokohama-shi (JP)

(21) Appl. No.: 19/076,764

(22) Filed: Mar. 11, 2025

(30) Foreign Application Priority Data
Mar. 11, 2024 (JP) 2024-036890

(51) Int. Cl. G02F 1/35; G01J 1/02; G02F 1/355

(52) U.S. Cl. CPC G02F 1/3501; G01J 1/0238; G02F 1/3534; G02F 1/3551; G02F 2203/69

(57) ABSTRACT

A wavelength conversion apparatus according to the present disclosure includes storage means storing a conversion efficiency map in which wavelength conversion efficiency for each of a plurality of input positions of input light on a reference plane of a nonlinear optical crystal that converts a wavelength of output light from a wavelength of the input light is stored in association with the input position, the conversion efficiency map being for each of a plurality of temperature conditions of the nonlinear optical crystal, incident position determining means for determining, based on the conversion efficiency maps under two or more of the temperature conditions selected from the storage means, an incident position where the input light is made incident on the nonlinear optical crystal, and control means for controlling moving means for moving relative positions of the nonlinear optical crystal and the input light.

### INCORPORATION BY REFERENCE

This application is based upon and claims the benefit of priority from Japanese patent application No. 2024-036890, filed on Mar. 11, 2024, the disclosure of which is incorporated herein in its entirety by reference for all purposes.

### BACKGROUND

The present disclosure relates to a wavelength conversion apparatus and a wavelength conversion method.

Patent Literatures 1 to 9 disclose wavelength conversion apparatuses in which nonlinear optical crystals are used.
[Patent Literature 1] Japanese Unexamined Patent Application Publication No. 2004-055695
[Patent Literature 2] Japanese Patent No. 5825642
[Patent Literature 3] Japanese Unexamined Patent Application Publication No. 2003-057696
[Patent Literature 4] Japanese Unexamined Patent Application Publication No. 2004-022946
[Patent Literature 5] Japanese Unexamined Patent Application Publication No. H10-268367
[Patent Literature 6] Japanese Patent No. 4729093
[Patent Literature 7] Japanese Unexamined Patent Application Publication No. 2006-317724
[Patent Literature 8] Japanese Patent No. 4565207
[Patent Literature 9] Japanese Patent No. 4572074

### SUMMARY

Stability of output light obtained by converting a wavelength of input light has been desired.

The present disclosure has been made in order to solve the problem described above, and an object of the present disclosure is to provide a wavelength conversion apparatus and a wavelength conversion method that can improve stability of output light.

A wavelength conversion apparatus according to the present disclosure includes: storage unit configured to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal; incident position determining unit configured to determine, based on the conversion efficiency maps under two or more of the temperature conditions selected from the storage unit, an incident position where the input light is made incident on the nonlinear optical crystal; and control unit configured to control, such that the input light is made incident on the incident position determined by the incident position determining unit, moving unit configured to move relative positions of the nonlinear optical crystal and the input light.

In the wavelength conversion apparatus, the incident position determining unit may specify, based on the conversion efficiency maps under the selected two or more temperature conditions, at least one matching coordinate that is a coordinate of the input position where the wavelength conversion efficiency in at least one of the temperature conditions is equal to or larger than a predetermined threshold; and determine the incident position from the at least one matching coordinate.

In the wavelength conversion apparatus, the incident position determining unit may specify, based on the conversion efficiency maps under the selected two or more temperature conditions, maximum conversion efficiency that is a largest one of the wavelength conversion efficiencies under the plurality of temperature conditions for respective coordinates in coordinates of the plurality of input positions, specify at least one matching coordinate that is a coordinate of the input position where the maximum conversion efficiency is equal to or larger than a predetermined threshold; and determine the incident position from the at least one matching coordinate.

In the wavelength conversion apparatus, the incident position determining unit may specify, based on the conversion efficiency maps under the selected two or more temperature conditions, at least one matching coordinate that is a coordinate of the input position where the wavelength conversion efficiencies under the plurality of temperature conditions are equal to or larger than a predetermined threshold; and determine the incident position from the at least one matching coordinate.

In the wavelength conversion apparatus, the incident position determining unit may generate a route including only a plurality of the matching coordinates; and determine the incident position from the matching coordinates in the route.

In the wavelength conversion apparatus, after determining a first matching coordinate in the route as the incident position, when determining a next incident position of the incident position, the incident position determining unit may determine, as the next incident position, a second matching coordinate that is the at least one matching coordinate in the route and is adjacent to the first matching coordinate and subsequently repeats this determination.

In the wavelength conversion apparatus, the incident position determining unit may determine the incident position such that the route is drawn with a single stroke.

In the wavelength conversion apparatus, the nonlinear optical crystal may be in contact with temperature adjusting unit configured to perform temperature adjustment for a nonlinear optical crystal on a predetermined surface side, the route may include a plurality of first line segments in a direction along the predetermined surface and a second line segment connecting the first line segments, and a length of the first line segments may be larger than a length of the second line segment.

In the wavelength conversion apparatus, the route may be generated to set, as a start point, the at least one matching coordinate belonging to the first line segment closest to the predetermined surface and set, as an end point, the at least one matching coordinate belonging to the first line segment most distant from the predetermined surface, or may be generated to set, as a start point, the at least one matching coordinate belonging to the first line segment most distant from the predetermined surface and set, as an end point, the at least one matching coordinate belonging to the first line segment closest to the predetermined surface.

In the wavelength conversion apparatus, the nonlinear optical crystal may be in contact with temperature adjusting unit configured to perform temperature adjustment for the nonlinear optical crystal on a predetermined surface side, and the control unit may set, as a target temperature, a temperature at which the wavelength conversion efficiency in the incident position specified based on the at least one conversion efficiency map is equal to or larger than a predetermined threshold and causes the temperature adjusting unit to adjust the temperature of the nonlinear optical crystal.

In the wavelength conversion apparatus, the control unit may monitor the wavelength conversion efficiency while moving the incident position onto a route and causes temperature adjusting unit to adjust a temperature of the nonlinear optical crystal such that the wavelength conversion efficiency is maximized.

In the wavelength conversion apparatus, the predetermined surface may include one to four surfaces among surfaces excluding an incident surface of the input light and an output surface of the output light of the nonlinear optical crystal.

In the wavelength conversion apparatus, the predetermined surface may be one surface among surfaces excluding an incident surface of the input light and an output surface of the output light of the nonlinear optical crystal, and the nonlinear optical crystal may be in contact with a holding member, a position of which is changed by the moving unit, on the surface side excluding the incident surface and the output surface.

In the wavelength conversion apparatus, a temperature difference between temperatures under adjacent temperature conditions corresponding to a selected plurality of the conversion efficiency maps may be smaller than a temperature phase matching allowable width of the nonlinear optical crystal.

In the wavelength conversion apparatus, a temperature difference between temperatures under adjacent temperature conditions corresponding to a selected plurality of the conversion efficiency maps may be equal to or smaller than a half of a temperature phase matching allowable width of the nonlinear optical crystal.

In the wavelength conversion apparatus, the incident position determining unit may specify, based on the at least one conversion efficiency map, a reference temperature at which the wavelength conversion efficiency in a predetermined reference coordinate is maximized; and determine the incident position based on the at least one conversion efficiency map at the reference temperature and the at least one conversion efficiency map for a temperature different from the reference temperature by a predetermined temperature.

In the wavelength conversion apparatus, the input light may include light in an ultraviolet region and light in an infrared region, and the nonlinear optical crystal may convert a wavelength through sum frequency mixing of the light in the ultraviolet region and the light in the infrared region.

In the wavelength conversion apparatus, the at least one conversion efficiency map may be generated under a plurality of temperature conditions and records the at least one conversion efficiency map in the storage unit.

A wavelength conversion method according to the present disclosure includes: a step of causing storage unit to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal; a step of causing incident position determining unit to determine, based on the conversion efficiency maps under two or more of the temperature conditions selected from the storage unit, an incident position where the input light is made incident on the nonlinear optical crystal; and a step of causing moving unit to move relative positions of the nonlinear optical crystal and the input light such that the input light is made incident on the determined incident position.

According to the present disclosure, it is possible to provide a wavelength conversion apparatus and a wavelength conversion method that can improve stability of output light.

The above and other objects, features and advantages of the present disclosure will become more fully understood from the detailed description given hereinbelow and the accompanying drawings.

### BRIEF DESCRIPTION OF DRAWINGS

FIG. 1 is a graph illustrating conversion efficiency of a nonlinear optical crystal, in which the horizontal axis indicates the temperature of the nonlinear optical crystal and the vertical axis indicates conversion efficiency;

FIG. 2 is a configuration diagram illustrating a wavelength conversion system according to a first embodiment;

FIG. 3A is a top view illustrating the nonlinear optical crystal in the wavelength conversion system according to the first embodiment;

FIG. 3B is a side view illustrating the nonlinear optical crystal in the wavelength conversion system according to the first embodiment;

FIG. 4 is a block diagram illustrating an information processing apparatus in the wavelength conversion system according to the first embodiment;

FIG. 5 is a block diagram illustrating an information processing apparatus in the wavelength conversion system according to another example of the first embodiment;

FIG. 6 is a diagram illustrating a conversion efficiency map stored by storage means in the information processing apparatus in the wavelength conversion system according to the first embodiment;

FIG. 7 is a diagram illustrating the conversion efficiency map stored by the storage means in the information processing apparatus in the wavelength conversion system according to the first embodiment and illustrates the conversion efficiency map in which the temperature is changed from a predetermined temperature by −1.2° C.;

FIG. 8 is a diagram illustrating the conversion efficiency map stored by the storage means in the information processing apparatus in the wavelength conversion system according to the first embodiment and illustrates the conversion efficiency map in which the temperature is changed from the predetermined temperature by −0.6° C.;

FIG. 9 is a diagram illustrating the conversion efficiency map stored by the storage means in the information processing apparatus in the wavelength conversion system according to the first embodiment and illustrates the conversion efficiency map in which the temperature is changed from the predetermined temperature by +0° C.;

FIG. 10 is a diagram illustrating the conversion efficiency map stored by the storage means in the information processing apparatus in the wavelength conversion system according to the first embodiment and illustrates the conversion efficiency map in which the temperature is changed from the predetermined temperature by +0.6° C.;

FIG. 11 is a diagram illustrating the conversion efficiency map stored by the storage means in the information processing apparatus in the wavelength conversion system according to the first embodiment and illustrates the conversion efficiency map in which the temperature is changed from the predetermined temperature by +1.2° C.;

FIG. 12 is a diagram illustrating the conversion efficiency map stored by the storage means in the information processing apparatus in the wavelength conversion system according to the first embodiment and is a diagram represented by wavelength conversion efficiency maximized at input positions in FIGS. 7 to 11;

FIG. 13 is a diagram illustrating a route including an incident position determined by incident position determining means in the information processing apparatus in the wavelength conversion system according to the first embodiment;

FIG. 14 is a flowchart illustrating a wavelength conversion method using the wavelength conversion system according to the first embodiment; and

FIG. 15 is a block diagram illustrating a wavelength conversion apparatus in the wavelength conversion system according to the first embodiment.

### DESCRIPTION OF EMBODIMENTS

A specific configuration of an embodiment is explained below with reference to the drawings. The following explanation indicates a preferred embodiment of the present disclosure. The scope of the present disclosure is not limited to the embodiment explained below. In the following explanation, contents denoted by the same reference numerals and signs indicate substantially the same contents.

First, in <problems found anew by the inventor>, problems found anew by the inventor about a wavelength conversion apparatus are explained. Subsequently, in <First Embodiment>, a wavelength conversion apparatus and a wavelength conversion method according to the present embodiment are explained. Note that the <problems found anew by the inventor> is also within the scope of the technical idea of the present embodiment. The technical scope of the present disclosure is not limited to uses and numerical values described in the <problems found anew by the inventor>.

### Problems Found Anew by the Inventor

For example, a photomask defect inspection apparatus sometimes use, from the viewpoint of improving optical resolution, a light source in a deep ultraviolet region having a short wavelength, in particular, a wavelength 250 nm or less as an irradiation light source. The photomask defect inspection apparatus desirably uses a continuous-output and high-output light source in order to enable high-speed inspection without interruption. For generation of such continuous light in a deep wavelength region, for example, as disclosed in Patent Literature 1, second harmonic generation and sum frequency generation by external resonator conversion using light of a visible or infrared laser light source is often used. In the external resonator conversion, a nonlinear optical crystal is installed in an external resonator.

As a nonlinear optical crystal for ultraviolet light generation, a CₛLiB₆O₁₀ crystal (hereinafter referred to as CLBO crystal), β-BaB₂O₄ crystal (hereinafter referred to as BBO crystal), and LiB₃O₅ crystal (hereinafter referred to as LBO crystal) are mainly used.

The second harmonic generation can be configured by a single excitation light source. In this regard, the second harmonic generation is simpler and higher in efficiency compared with the sum frequency generation that requires two light sources. However, a limit of a wavelength that can be generated in the second harmonic generation is 205 nm at which phase matching is obtained by the BBO crystal. Generation of wavelength light equal to or smaller than 205 nm requires the sum frequency generation. As a crystal for the sum frequency generation, all of the CLBO crystal, the BBO crystal, and the LBO crystal can be used.

For example, Patent Literature 2 discloses a technique for generating continuous output ultraviolet light having a wavelength of 233 to 234 nm with the second harmonic generation of an external resonator type using the BBO crystal and further discloses a technique for sum frequency-mixing light having a wavelength of 1111 to 1130 nm with the CLBO crystal arranged in a second external resonator and generating light having a wavelength of 193.2 to 193.6 nm.

In both of the second harmonic generation and the sum frequency generation, in order to generate practical ultraviolet light, it is essential to satisfy a so-called phase matching condition that is a special condition concerning a relation between a refractive index and a wavelength of incident light in a nonlinear optical crystal and a refractive index and a wavelength of generated light. A simplified phase matching condition in the case of the sum frequency generation is represented by the following Expression (1), where λ represents a wavelength and n represents a refractive index of the nonlinear optical crystal.

$$( {n}_{3} / {λ}_{3} ) = ( {n}_{1} / {λ}_{1} ) + ( {n}_{2} / {λ}_{2} ) \qquad ( 1 )$$

As disclosed in Patent Literature 2, when deep ultraviolet light having a wavelength of 193.2 to 193.6 nm is generated by sum frequency-mixing, using the CLBO crystal, ultraviolet light having a wavelength of 233 to 234 nm and infrared light having a wavelength of 1111 to 1130 nm, it is possible to cause the CLBO crystal to operate under a special condition called non-critical phase matching in which an angle formed by an incident light axis and a crystal axis is orthogonal. Accordingly, it is possible to generate high-efficiency and high-output deep ultraviolet light.

However, the refractive index of the nonlinear optical crystal is a function of temperature. In order to satisfy the phase matching condition explained above, it is necessary to precisely adjust and stabilize the temperature of the nonlinear optical crystal with means such as a Peltier element.

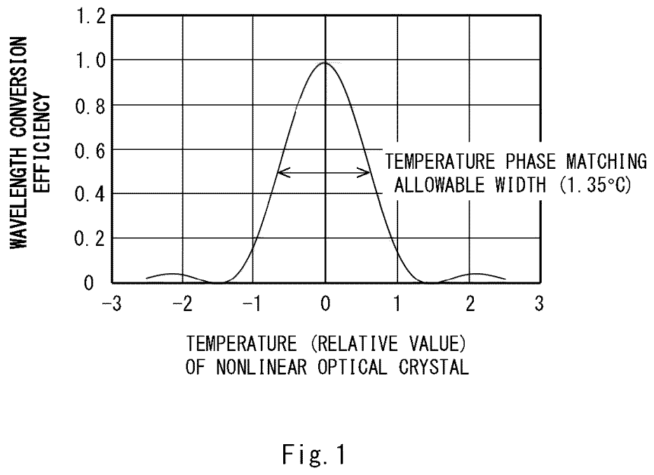

In the case of the non-critical phase matching, temperature dependency of the refractive index is particularly high. For example, in the case of a CLBO crystal having a length of 20 mm, in calculation, if the temperature deviates 0.3° C. from an optimum temperature, conversion efficiency decreases 10% as illustrated in FIG. 1. Here, FIG. 1 is a graph illustrating wavelength conversion efficiency of the nonlinear optical crystal. The horizontal axis indicates relative temperature with respect to temperature 0 for maximizing conversion efficiency of the nonlinear optical crystal and the vertical axis indicates wavelength conversion efficiency. Therefore, in order to keep output of output light constant, it is necessary to stabilize the temperature as precisely as possible (for example, at ±0.05° C. or less). Note that a temperature range (full width at half maximum) of a range in which the output of the output light does not halve is called temperature phase matching allowable width. In the case of FIG. 1, the temperature phase matching allowable width is 1.35° C.

Deep ultraviolet light having a wavelength of 193 nm has high photon energy. For this reason, if the output light is continuously generated while the position of the CLBO crystal is fixed, optical damage occurs in the nonlinear optical crystal itself in a short time and the wavelength conversion efficiency is deteriorated. As a technique for solving such a problem, as disclosed in Patent Literatures 3 to 7, many techniques for changing a position where laser light passes through the nonlinear optical crystal have been proposed.

However, the CLBO crystal has low thermal conductivity. Thus, when the temperature is controlled from the periphery by a Peltier element or the like, it is difficult to keep the temperature of the entire CLBO crystal uniform. For that reason, when the CLBO crystal is translated, in general, it is difficult to keep the phase matching condition. A problem occurs in that output of wavelength-converted output light decreases.

As means for solving this problem, for example, as disclosed in Patent Literature 8, a technique for adjusting the temperature of a nonlinear optical crystal has been proposed. Specifically, in Patent Literature 8, the nonlinear optical crystal is translated and output of incident light is adjusted such that the output of the wavelength-converted output light becomes substantially constant. At the same time, a temperature regulator is controlled to adjust the temperature of the nonlinear optical crystal such that the output of the incident light is minimized in each of a plurality of temperature adjustment periods.

Uniform conversion efficiency cannot always be obtained in an entire cross section perpendicular to an optical axis of the CLBO crystal. This is because the CLBO crystal is created through various processes in which conversion efficiency is nonuniform in growth and machining of the CLBO crystal. Since the quality of the CLBO crystal is nonuniform in general in this way, when the CLBO crystal is moved, input light passes a region with low quality and sufficient converted light output cannot be sometimes obtained even if the temperature of the CLBO crystal is optimized. In a semiconductor inspection apparatus or the like to which input light needs to be continuously input, practicality is sometimes hindered.

As a method of solving this problem, as disclosed in Patent Literature 9, a wavelength conversion apparatus including storage means for storing in advance output of wavelength-converted output light at the time when a nonlinear optical crystal is moved has been proposed. The wavelength conversion apparatus sequentially select, based on the output stored in the storage means, incident positions where the output of the output light indicates a predetermined threshold or more among incident positions to which laser light is input and makes the laser light incident on the incident position. This method is used, for example, when ultraviolet light having a wavelength of 266 nm is generated from visible light having a wavelength of 532 nm using the CLBO crystal.

The inventor found that it is sometimes difficult to make the wavelength conversion apparatus practical with an apparatus configuration disclosed in Patent Literature 9 and the like when a CLBO crystal that sum frequency-mixes infrared light having a wavelength near 1110 nm and ultraviolet light having a wavelength near 234 nm to generate deep ultraviolet light having a wavelength near 193 nm is used.

A main reason for the above is as explained below. The output of the wavelength-converted output light changes according to not only the quality of the nonlinear optical crystal but also nonuniformity of a temperature distribution of the nonlinear optical crystal. This is because, if a nonuniform temperature distribution in a region where the input light passes (in both of an in-plane direction and an optical axis direction) is present, the phase matching condition indicated by Expression (1) is only partially kept.

A temperature distribution in a rhombus-shaped nonlinear optical crystal called Brewster cut used when the wavelength-converted output light is continuously output is more nonuniform and complicated compared with a rectangular parallelepiped crystal. The inventor found that the rhombus-shaped nonlinear optical crystal has a region where wavelength conversion efficiency is low even if the quality of the entire nonlinear optical crystal is satisfactory.

In addition, the CLBO crystal that sum frequency-mixes infrared light having a wavelength near 1110 nm and ultraviolet light having a wavelength near 234 nm to generate deep ultraviolet light having a wavelength near 193 nm enables high efficiency wavelength conversion through non-critical phase matching. However, in return for this, the CLBO crystal has a characteristic that the CLBO crystal is extremely sensitive to the temperature of the nonlinear optical crystal through which the input light passes.

In the example explained above, the output of the output light halves with a change of 0.67° C. For example, the inventor found that even a CLBO crystal having a size of 5×5×20 mm often used in general has at least a temperature distribution of 1° C. because the thermal conductivity of the CLBO crystal is low. When the temperature changes 1° C., output of output light having a wavelength of 193 nm does not reach even 20% of output that should be obtained if the temperature is optimized.

For application to a wavelength conversion apparatus that continuously output output light in a long period like the semiconductor inspection apparatus or the like, a nonlinear optical crystal having a relatively large sectional area is necessary. However, for example, with a size of 8×8×20 mm, a temperature difference of 2° C. or more sometimes occurs in the nonlinear optical crystal. In addition, there is also a problem in that an optimum temperature for maximizing wavelength conversion efficiency of the nonlinear optical crystal changes with time according to absorption of the generated output light itself having the wavelength of 193 nm.

For that reason, a method of detecting and storing the output of the wavelength-converted output light while moving the nonlinear optical crystal has to find an optimum temperature and measure the output of the output light every time the nonlinear optical crystal is moved. For example, when the cross section of the nonlinear optical crystal is divided into 50×40=2000 measurement points and temperature for maximizing the wavelength conversion efficiency at all the measurement points is found to obtain a two-dimensional distribution, assuming that one measurement point can be measured in five minutes, 10,000 minutes, that is, 167 hours are required in total. However, in the first place, the method requiring such a long measurement time worsens damage to the nonlinear optical crystal. Therefore, this method is a method considered to have no practicality in the semiconductor inspection apparatus or the like requested to operate for 24 hours in 365 days.

Thus, the inventor earnestly studied characteristics of a nonlinear optical crystal such as a CLBO crystal that sum frequency-mixes infrared light having a wavelength near 1110 nm and ultraviolet light having a wavelength near 235 nm and generates deep ultraviolet light having a wavelength near 193 nm. The inventor changed a holding temperature of the nonlinear optical crystal five or more times and acquired a two-dimensional distribution (a conversion efficiency map) in the cross section of the nonlinear optical crystal of a ratio of output of output light having a wavelength of 193 nm to output of input light having a wavelength of 235 nm (output of output light/output of input light). Accordingly, the inventor found that it is possible to obtain a practical distribution by adopting a ratio maximized at points as an evaluation value of the points.

### First Embodiment

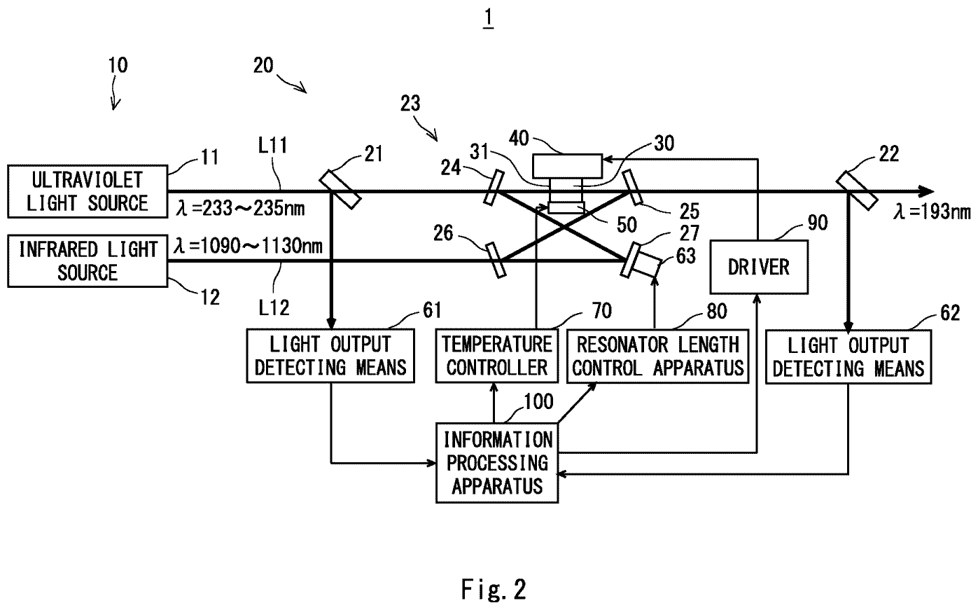

Subsequently, a wavelength conversion apparatus according to a first embodiment is explained. FIG. 2 is a configuration diagram illustrating a wavelength conversion system 1 according to the first embodiment. As illustrated in FIG. 2, the wavelength conversion system 1 includes a light source 10, an optical system 20, a nonlinear optical crystal 30, moving means 40, temperature adjusting means 50, optical output detecting means 61, optical output detecting means 62, a temperature controller 70, a resonator length control apparatus 80, a driver 90, and an information processing apparatus 100. In the present embodiment, the entire wavelength conversion system 1 including the information processing apparatus 100 may be referred to as wavelength conversion apparatus or the information processing apparatus 100 may be referred to as wavelength conversion apparatus. An apparatus obtained by adding several members configuring the wavelength conversion system 1 to the information processing apparatus 100 may be referred to as wavelength conversion apparatus.

The light source 10 includes, for example, an ultraviolet light source 11 and an infrared light source 12. The ultraviolet light source 11 generates laser light L11 including ultraviolet light having a wavelength λ of λ=233 to 235 nm. The laser light L11 may have a center wavelength of, for example, λ=234 nm. The infrared light source 12 generates laser light L12 including infrared light having the wavelength λ of λ=1090 to 1130 nm. The laser light L12 may have a center wavelength at, for example, λ=1110 nm. Note that the light source 10 is not limited to the ultraviolet light source 11 and the infrared light source 12 and may be a light source that generates light having another wavelength if the nonlinear optical crystal 30 outputs output light wavelength-converted from input light.

The optical system 20 includes a mirror 21, a mirror 22, and a resonator 23. The mirror 21 reflects a part of the laser light L11 to the optical output detecting means 61. The mirror 22 reflects a part of output light wavelength-converted in the nonlinear optical crystal 30 to the optical output detecting means 62. The mirror 21 and the mirror 22 may be half-silvered mirrors, unpolarized beam splitters, or the like.

The resonator 23 includes, for example, a mirror 24, a mirror 25, a mirror 26, and a mirror 27. The resonator 23 may include an optical member other than these mirrors. The plurality of mirrors 24 to 27 are disposed in the resonator 23 such that the laser light L11 and the laser light L12 perform sum frequency mixing in the nonlinear optical crystal 30. The plurality of mirrors 24 to 27 may be, for example, half-silvered mirrors or unpolarized beam splitters. For example, the plurality of mirrors 24 to 27 are disposed such that an optical axis of the laser light L11 and an optical axis of the laser light L12 overlap in the nonlinear optical crystal 30.

For example, the laser light L11 is made incident on the mirror 24. The laser light L11 transmitted through the mirror 24 is made incident on the nonlinear optical crystal 30. The laser light L11 transmitted through the nonlinear optical crystal 30 is transmitted through the mirror 25.

For example, the laser light L12 is made incident on the mirror 26. The laser light L12 transmitted through the mirror 26 is made incident on the mirror 27. The laser light L12 reflected on the mirror 27 is made incident on the mirror 24. The laser light L12 reflected on the mirror 24 is made incident on the nonlinear optical crystal 30. The laser light L12 transmitted through the nonlinear optical crystal 30 is reflected on the mirror 25. The laser light L12 reflected on the mirror 25 is made incident on the mirror 26. The laser light L12 reflected on the mirror 26 coaxially overlaps the laser light L12 emitted from the infrared light source 12 and is made incident on the mirror 27.

As explained above, the resonator 23 is configured to increase the intensity of the laser light L12 with the four mirrors 24 to 27. Note that the resonator 23 may be configured to increase the intensity of the laser light L12 with not only the four mirrors 24 to 27 but also three or less or five or more mirrors.

The resonator length control apparatus 80 controls the resonator length of the resonator 23. For example, the resonator length control apparatus 80 is connected to an actuator 63, which moves the position of the mirror 27, and servo-controls the position of the mirror 27 such that the intensity of the laser light L12 circling in the resonator 23 is continuously increased by a positive interference effect.

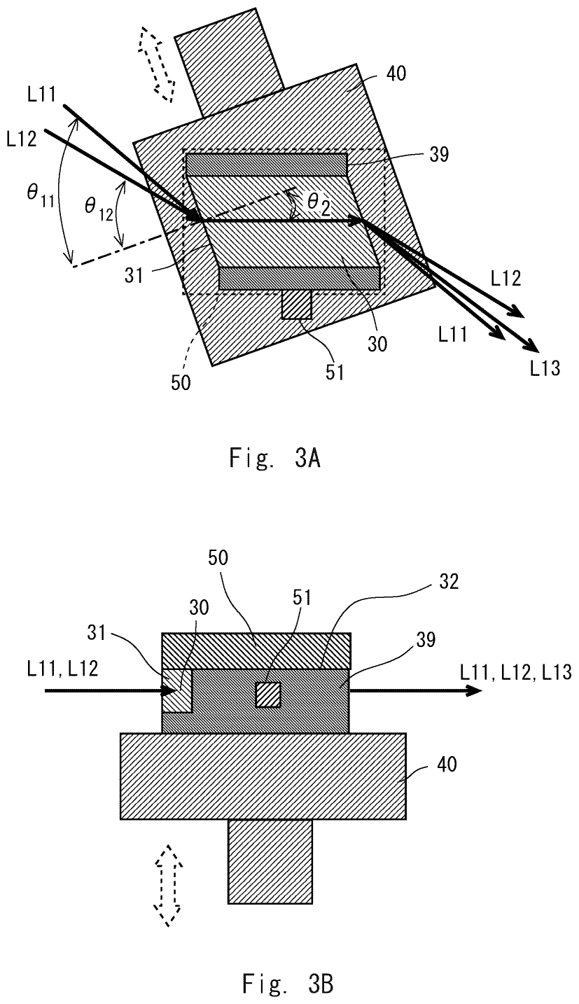

FIG. 3A is a top view illustrating the nonlinear optical crystal 30 in the wavelength conversion system 1 according to the first embodiment. FIG. 3B is a side view illustrating the nonlinear optical crystal 30 in the wavelength conversion system 1 according to the first embodiment. As illustrated in FIG. 3A and FIG. 3B, the nonlinear optical crystal 30 is fixed to a holding member 39. Accordingly, the holding member 39 holds the nonlinear optical crystal 30. The holding member 39 is fixed to the moving means 40. Accordingly, the moving means 40 moves the holding member 39 and the nonlinear optical crystal 30. The temperature adjusting means 50 is attached to the holding member 39 or is directly attached to the nonlinear optical crystal 30. A temperature sensor 51 may be attached to be in contact with the holding member 39. The temperature sensor 51 may be disposed near the nonlinear optical crystal 30. The temperature sensor 51 senses the temperature at a predetermined position in the nonlinear optical crystal 30.

The nonlinear optical crystal 30 wavelength-converts the laser light L11 and the laser light L12 that are incident input light. The nonlinear optical crystal 30 outputs wavelength-converted output light L13. The nonlinear optical crystal 30 includes, for example, a CLBO crystal. Note that the nonlinear optical crystal 30 is not limited to the CLBO crystal and may be a BBO crystal or an LBO crystal if the nonlinear optical crystal 30 is a crystal that converts a wavelength of output light from a wavelength of input light. Note that, in the above explanation, the laser light L11 transmitted through the nonlinear optical crystal 30 is transmitted through the mirror 25. However, instead, the laser light L11 transmitted through the nonlinear optical crystal 30 may be reflected on the mirror 25 and the laser light L11 may be resonated as explained below. That is, the laser light L11 is reflected on the mirror 25 and is made incident on the mirror 26. The laser light L11 reflected on the mirror 26 is made incident on the mirror 27. The laser light L11 reflected on the mirror 27 is made incident on the mirror 24. The laser light L11 reflected on the mirror 24 coaxially overlaps the laser light L11 emitted from the ultraviolet light source 11 and is made incident on the nonlinear optical crystal 30.

The nonlinear optical crystal 30 has a reference plane 31. The reference plane 31 is a surface on which the laser light L11 and the laser light L12 are made incident. The reference plane 31 is preferably disposed such that, for example, both of an incident angle θ₁₁ of the laser light L11 and an incident angle θ₁₂ of the laser light L12 are near a Brewster's angle or 10° or less at most. Accordingly, it is possible to reduce a reflection loss of the incident laser light L11 and the incident laser light L12. The reference plane 31 is formed in a rhombus sectional shape such that the laser light L11 and the laser light L12 traveling in the nonlinear optical crystal 30 are substantially parallel to four surfaces excluding incident and emission surfaces. Such a shape of the nonlinear optical crystal 30 is referred to as Brewster cut. The laser light L11 and the laser light L12 enter the inside of the nonlinear optical crystal 30 at a refractive angle θ₂ with respect to the incident surface. The nonlinear optical crystal 30 is configured to be near a Brewster's angle (incident angle θ₁₂+refractive angle θ₂=90°) with respect to the laser light L12 to prevent the laser light L12 from reflecting on the reference plane 31. In this case, since the incident angle θ₁₁ of the laser light L11 is also within 10° from the Brewster's angle, the reflection is sufficiently small. For the laser light L11 and the laser light L12 to overlap in the nonlinear optical crystal 30 (the refractive angle θ₂ to be equal), the incident angle θ₁₁ of the laser light L11 having a short wavelength needs to be set larger than the incident angle θ₁₂. The nonlinear optical crystal 30 may be configured using this phenomenon such that the laser light L11 is not reflected on or transmitted through the mirror 24 and the mirror 25.

The nonlinear optical crystal 30 may have a predetermined surface 32. The nonlinear optical crystal 30 may be in contact with the temperature adjusting means 50 that performs temperature adjustment for the nonlinear optical crystal 30 on the predetermined surface 32 side. The predetermined surface 32 may be one surface among surfaces excluding an incident surface of input light (for example, the reference plane 31) and an output surface of output light of the nonlinear optical crystal 30. The nonlinear optical crystal 30 may be in contact with the holding member 39 to which the moving means 40 for moving an incident position of the nonlinear optical crystal 30 is fixed. A surface on which the nonlinear optical crystal 30 is in contact with the holding member 39 to which the moving means 40 is fixed may be a surface excluding the incident surface (for example, the reference plane 31) and the output surface of the output light. The surface on which the nonlinear optical crystal 30 is in contact with the holding member 39 to which the moving means 40 is fixed may be, for example, the same surface as a surface (the predetermined surface 32) on which the nonlinear optical crystal 30 is in contact with the temperature adjusting means 50, a surface opposed to the predetermined surface 32, or a surface other than these surfaces. Note that the predetermined surface 32 may include one to four surfaces among surfaces excluding the incident surface of input light and the output surface of output light of the nonlinear optical crystal 30. For example, the predetermined surface 32 may include four surfaces among surfaces connecting the incident surface and the output surface. Since the predetermined surface 32 includes a plurality of surfaces, it is possible to improve uniformity of the temperature of the nonlinear optical crystal 30.

The moving means 40 changes an incident position where input light is made incident on the nonlinear optical crystal 30. That is, the moving means 40 changes relative positions of the nonlinear optical crystal 30 and the input light. For example, the moving means 40 two-dimensionally moves the reference plane 31 in the nonlinear optical crystal 30 within a surface parallel to the reference plane 31. As illustrated in FIG. 3, in the case of the nonlinear optical crystal 30 of the Brewster cut type, the moving means 40 moves the nonlinear optical crystal 30 in parallel to the reference plane 31. In an example explained below, the moving means 40 is explained as changing the position of the nonlinear optical crystal 30 to change the relative positions of the nonlinear optical crystal 30 and the input light. However, the moving means 40 may change the positions of the ultraviolet light source 11, the infrared light source 12, the mirror 21, and the like to change the relative positions of the nonlinear optical crystal 30 and the input light.

The moving means 40 includes a driving apparatus such as a motor or an encoder. For example, the moving means 40 is connected to the driver 90 in a state of being capable of transmitting information with a signal line including at least one of radio or a wire. The moving means 40 changes the incident position based on a signal transmitted from the driver 90. Note that the moving means 40 may be connected to, not via the driver 90, the information processing apparatus 100 in the state of being capable of transmitting information with the signal line and change the incident position based on a signal transmitted from the information processing apparatus 100 having a function of the driver 90.

The temperature adjusting means 50 heats or cools the nonlinear optical crystal 30. The temperature adjusting means 50 is connected to the temperature controller 70 together with the temperature sensor 51 in the state of being capable of transmitting information with the signal line. The temperature controller 70 controls the temperature adjusting means 50 such that a setting temperature designated by the information processing apparatus 100 and a measured temperature by the temperature sensor 51 coincide. Note that the temperature adjusting means 50 may be connected to, not via the temperature controller 70, the information processing apparatus 100 in the state of being capable of transmitting information with the signal line and heat or cool the nonlinear optical crystal 30 based on a signal transmitted from the information processing apparatus 100 having the function of the temperature controller 70.

The optical output detecting means 61 detects output of input light such as the laser light L11 and the laser light L12 made incident on the nonlinear optical crystal 30. The optical output detecting means 61 is connected to the information processing apparatus 100 in the state of being capable of transmitting information with the signal line. The optical output detecting means 61 outputs the detected output of the input light to the information processing apparatus 100.

The optical output detecting means 62 detects output of output light wavelength-converted in the nonlinear optical crystal 30. The optical output detecting means 62 is connected to the information processing apparatus 100 in the state of being capable of transmitting information with the signal line. The optical output detecting means 62 outputs the detected output of the output light to the information processing apparatus 100.

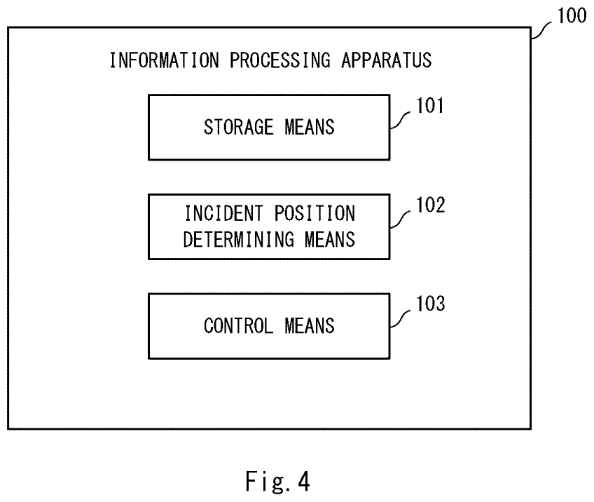

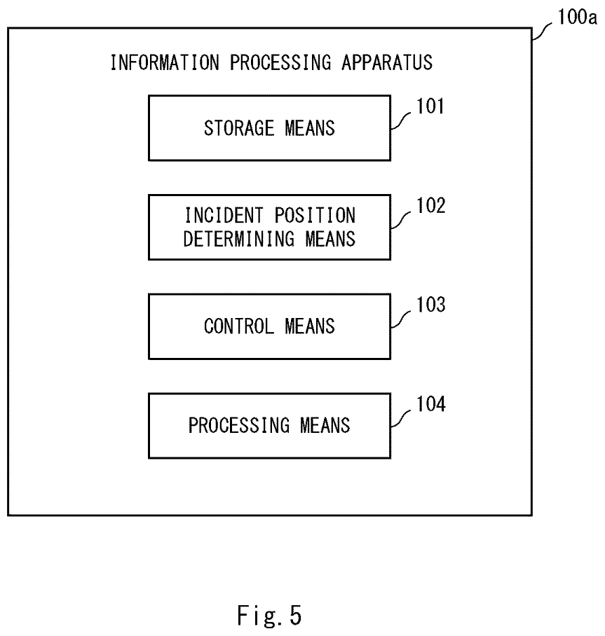

FIG. 4 is a block diagram illustrating the information processing apparatus 100 in the wavelength conversion system 1 according to the first embodiment. As illustrated in FIG. 4, the information processing apparatus 100 includes storage means 101, incident position determining means 102, and control means 103. The information processing apparatus 100 includes information processing equipment such as a PC, a server, or a smartphone. FIG. 5 is a block diagram illustrating an information processing apparatus 100a in the wavelength conversion system 1 according to another example of the first embodiment. As illustrated in FIG. 5, the information processing apparatus 100a may further include processing means 104.

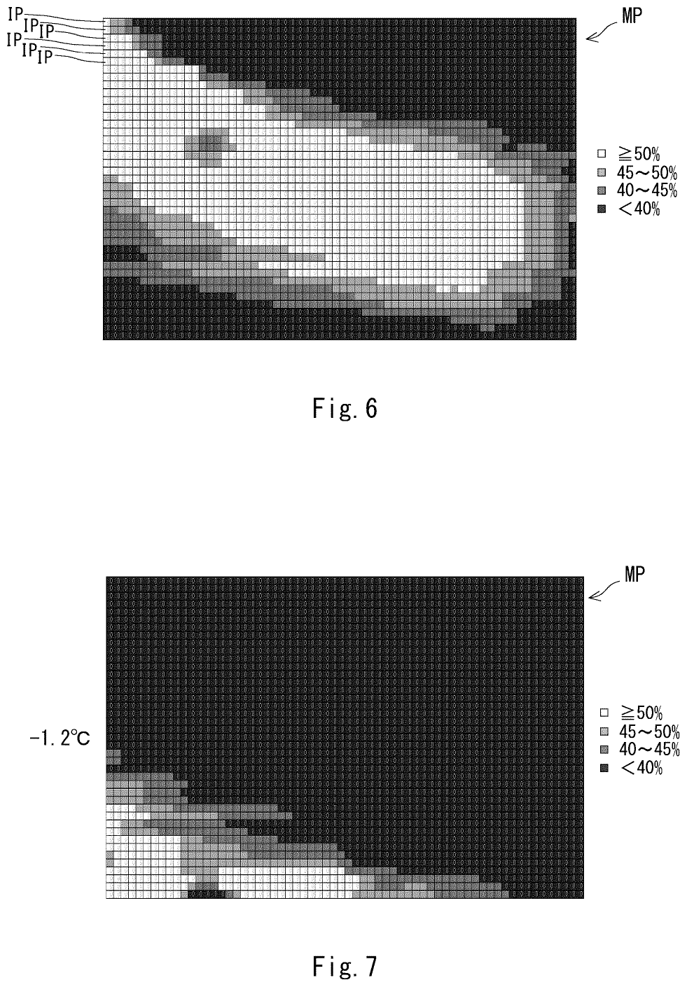

FIG. 6 is a diagram illustrating a conversion efficiency map MP stored by the storage means 101 in the information processing apparatus 100 in the wavelength conversion system 1 according to the first embodiment. In FIG. 6, several reference numerals and signs are omitted to prevent the figure from becoming complicated. The same applies to the subsequent figures. As illustrated in FIG. 6, the storage means 101 stores the conversion efficiency map MP. The conversion efficiency map MP is a map in which wavelength conversion efficiency for each of a plurality of input positions IP of input light on the reference plane 31 of the nonlinear optical crystal 30 is stored in association with the input position IP. Note that a position where the input light is made incident on the conversion efficiency map MP is referred to as input position IP and a position where input light is made incident determined by the incident position determining means 102 explained below is referred to as incident position to distinguish both the positions.

The conversion efficiency map MP may not be created in the wavelength conversion system 1 if the conversion efficiency map MP is stored in the storage means 101. Note that the conversion efficiency map MP may be created in the following procedure using the wavelength conversion system 1. In that case, the information processing apparatus 100a illustrated in FIG. 5 is used.

First, a predetermined position of the nonlinear optical crystal 30 is adjusted to a predetermined temperature. The predetermined position may be, for example, the vicinity of the center of the nonlinear optical crystal 30. In that case, input light and output light are positioned by the moving means 40 to pass a predetermined position such as the vicinity of the center of the reference plane 31 of the nonlinear optical crystal 30.

Subsequently, temperature of the nonlinear optical crystal 30 at which output light detected by the optical output detecting means 62 is maximized is found while a setting temperature of the nonlinear optical crystal 30 being adjusted by the temperature adjusting means 50. The reference plane 31 of the nonlinear optical crystal 30 is two-dimensionally scanned by the moving means 40 while the temperature of the predetermined position being maintained at the temperature. Accordingly, output detected by the optical output detecting means 61 and output detected by the optical output detecting means 62 when input light is made incident on input positions IP on the reference plane 31 are taken into the information processing apparatus 100a together with the input positions IP.

Subsequently, the processing means 104 of the information processing apparatus 100a calculates wavelength conversion efficiencies of the input positions IP and performs mapping. The wavelength conversion efficiency is, for example, as explained above, a ratio of output of output light having a wavelength of 193 nm to output of input light having a wavelength of 235 nm (output of output light/output of input light). In this way, as illustrated in FIG. 6, the conversion efficiency map MP, which is a distribution diagram of the wavelength conversion efficiency on the reference plane 31 of the nonlinear optical crystal 30, can be created in the information processing apparatus 100a. Note that, in order to perform actual wavelength conversion processing in a state in which reproducibility of a relation between the wavelength conversion efficiency indicated by the conversion efficiency map MP stored in the storage means 101 and a temperature condition is improved, it is preferable to make a positional relation between the nonlinear optical crystal 30 and the temperature adjusting means 50 the same respectively at the time when the conversion efficiency map MP is generated and at the time when the wavelength conversion processing is performed using the conversion efficiency MP. For example, it is preferable to make a contact surface between the nonlinear optical crystal 30 and the temperature adjusting means 50 the same at the time when the conversion efficiency map MP is generated and at the time when the wavelength conversion processing is performed using the conversion efficiency map MP.

In FIG. 6, the input position IP where the wavelength conversion efficiency is 50% or more is indicated by white, the input position IP where the wavelength conversion efficiency is 45% to 50% is indicated by light gray, the input position IP where the wavelength conversion efficiency is 40% to 45% is indicated by dark gray, and the input position IP where the wavelength conversion efficiency is less than 40% is indicated by black.

In FIG. 6, an example of measurement for a CLBO crystal having a special shape called Brewster cut is illustrated. A region where high wavelength conversion efficiency can be obtained depending on such a special shape is obliquely present on the reference plane 31 in the present embodiment. A region where wavelength conversion efficiency is low is present on the left side on the reference plane 31 in the present embodiment. Note that such a shape of the region with the high wavelength conversion efficiency and the region with the low wavelength conversion efficiency is an example. The regions sometimes show another shape.

In the related art, the input positions IP where the wavelength conversion efficiency is high are sequentially used as incident positions of input light using this result. However, as in the related art, in output of 193 nm light by non-critical phase matching, a temperature allowable width of phase matching is extremely narrow. Therefore, in the related art, on the reference plane 31 of the nonlinear optical crystal 30, a region usable as an incident position is limited to a limited portion of a center portion.

In contrast, in the present embodiment, the temperature of the nonlinear optical crystal 30 is changed to create the conversion efficiency maps MP at a plurality of temperatures. A region where wavelength conversion efficiencies are high at temperatures is used as an incident position. For example, even if the center portion of the reference plane 31 is a region usable as an incident position at a certain temperature, a peripheral portion of the reference plane 31 is sometimes a region usable as an incident position at another temperature. Therefore, by changing the temperature of the nonlinear optical crystal 30, a wide range of the reference plane 31 can be used as an incident position.

FIGS. 7 to 11 are diagrams illustrating the conversion efficiency map MP stored by the storage means 101 in the information processing apparatus 100 in the wavelength conversion system 1 according to the first embodiment and respectively illustrate the conversion efficiency maps MP in which temperature is changed by −1.2° C., −0.6° C., ±0° C., ±0.6° C., and +1.2° C. from a predetermined temperature. As illustrated in FIGS. 7 to 11, the storage means 101 may store the conversion efficiency map MP for each of a plurality of temperature conditions of the nonlinear optical crystal 30. Note that the temperature condition may be a setting temperature for the nonlinear optical crystal 30. For example, the temperature condition may be a control temperature for the temperature adjusting means 50 or may be a temperature at a predetermined position of the nonlinear optical crystal 30 (for example, the contact surface between the nonlinear optical crystal 30 and the temperature adjusting means 50) that has changed by being heated or cooled by the temperature adjusting means 50. Alternatively, the temperature condition may be a temperature at a predetermined position of the holding member 39.

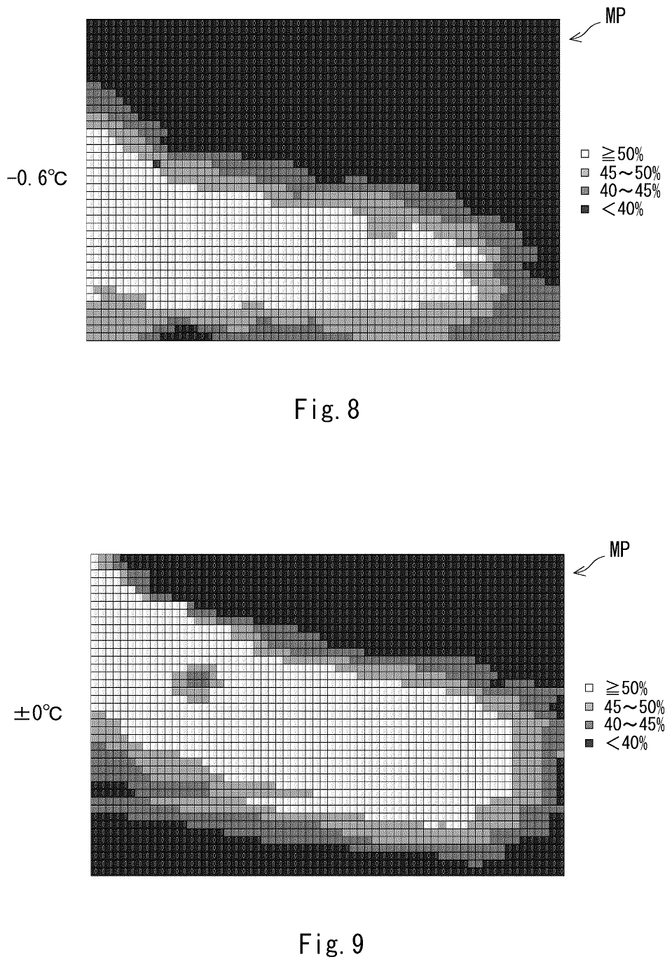

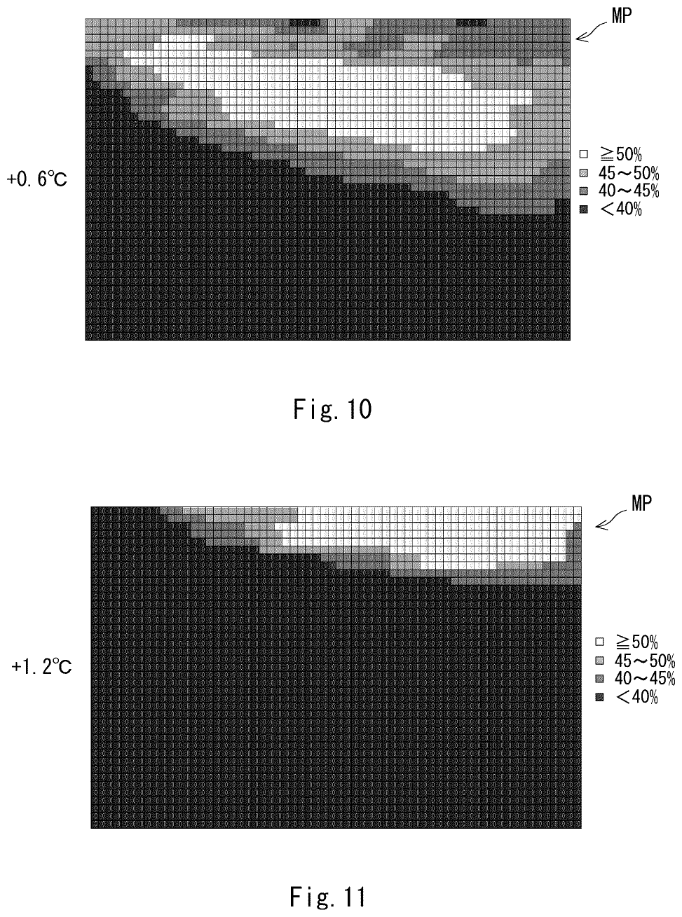

As illustrated in FIG. 7, in the case of −1.2° C. from the predetermined temperature, regions where high wavelength conversion efficiency can be obtained are distributed on the lower side of the conversion efficiency map MP. As illustrated in FIG. 8, in the case of −0.6° C. from the predetermined temperature, regions where high wavelength conversion efficiency can be obtained are distributed below the center of the conversion efficiency map MP. As illustrated in FIG. 9, in the case of ±0° C. from the predetermined temperature, regions where high wavelength conversion efficiency can be obtained are distributed in the center portion of the conversion efficiency map MP. As illustrated in FIG. 10, in the case of +0.6° C. from the predetermined temperature, regions where high wavelength conversion efficiency can be obtained are distributed above the center of the conversion efficiency map MP. As illustrated in FIG. 11, in the case of +1.2° C. from the predetermined temperature, regions where high wavelength conversion efficiency can be obtained are distributed on the upper side of the conversion efficiency map MP.

The incident position determining means 102 determines, based on the conversion efficiency maps MP under two or more temperature conditions selected from the storage means 101, an incident position where input light is made incident on the nonlinear optical crystal 30. In FIGS. 7 to 11, the incident position determining means 102 selects the conversion efficiency maps MP under five temperature conditions (respectively −1.2° C., −0.6° C., +0° C., +0.6° C., and +1.2° C. from the predetermined temperature). In this way, the incident position determining means 102 may select the conversion efficiency maps MP under five or more temperature conditions. Accordingly, a wide region of the conversion efficiency maps MP can be used as an incident position. However, the incident position determining means 102 is not limited to this and may select the conversion efficiency maps MP under four or less temperature conditions or may select the conversion efficiency maps MP under six or more temperature conditions.

A temperature difference among the temperature conditions is set to 0.6° C. The temperature difference of 0.6° C. is equivalent to a half or less value of a temperature phase matching allowable width 1.35° C. of the nonlinear optical crystal 30 in the present embodiment. By setting the temperature difference among the temperature conditions corresponding to the selected plurality of conversion efficiency maps MP to a half or less of the temperature phase matching allowable width of the nonlinear optical crystal 30, the wavelength conversion efficiencies at the input positions IP in any one of the conversion efficiency maps MP having the different temperature conditions are close to the maximum. The temperature difference may be set smaller to create and select the conversion efficiency maps MP under more temperature conditions. For example, the temperature difference may be set to 0.3° C. and the temperature conditions may be nine temperature conditions of −1.2° C., −0.9° C., −0.6° C., −0.3° C., ±0° C., +0.3° C., +0.6° C., +0.9° C., and +1.2° C. The temperature range may be set wider than ±1.2° C. Accordingly, the number of conversion efficiency map MP increases and a time required for creation becomes longer, more precise creation of the conversion efficiency map MP is possible.

The incident position determining means 102 specifies, based on the conversion efficiency maps MP under the selected two or more temperature conditions, a coordinate of the input position IP where wavelength conversion efficiency under at least one temperature condition is equal to or larger than a predetermined threshold. The coordinate of the input position IP where the wavelength conversion efficiency is equal to or larger than the predetermined threshold is referred to as matching coordinate. The incident position determining means 102 determines an incident position from the specified matching coordinate.

Specifically, for example, the incident position determining means 102 specifies, as the matching coordinate, a coordinate of the input position IP where the wavelength conversion efficiency in the conversion efficiency map MP is 50% or more. That is, in the examples illustrated in FIGS. 7 to 11, the incident position determining means 102 determines an incident position from regions indicated by white in the conversion efficiency map MP. Note that the predetermined threshold is not limited to 50% and may be another value.

The incident position determining means 102 specifies, based on the conversion efficiency maps MP under the selected two or more temperature conditions, a matching coordinate of an input position where the wavelength conversion efficiencies under a plurality of temperature conditions are equal to or larger than the predetermined threshold. The incident position determining means 102 may determine an incident position from the matching coordinate.

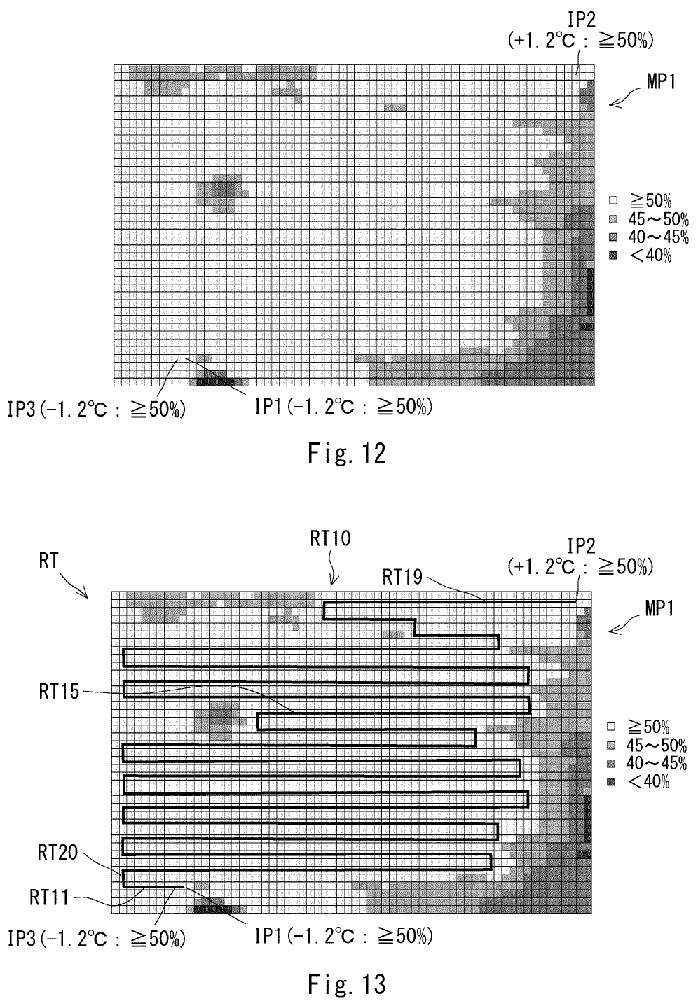

FIG. 12 is a diagram illustrating a conversion efficiency map MP1 stored by the storage means 101 in the information processing apparatus 100 in the wavelength conversion system 1 according to the first embodiment and is a diagram represented by wavelength conversion efficiency maximized at the input positions IP in FIGS. 7 to 11. As illustrated in FIG. 12, the input positions IP in the conversion efficiency map MP1 have maximum conversion efficiency at which wavelength conversion efficiency is maximized in a changed temperature range. For example, an input position IP1 indicates maximum conversion efficiency (≥50%) at temperature of −1.2° C. from the predetermined temperature. An input position IP2 indicates maximum conversion efficiency (≥50%) at temperature of +1.2° C. from the predetermined temperature. An input position IP3 indicates maximum conversion efficiency (≥50%) at temperature of −1.2° C. from the predetermined temperature.

As illustrated in FIG. 12, by changing the temperature of the nonlinear optical crystal 30, it is possible to obtain high wavelength conversion efficiency not only in the region of the center portion of the conversion efficiency map MP illustrated in FIG. 9 but also in a wide range of the conversion efficiency map MP1. However, it can also be seen that a region where sufficient wavelength conversion efficiency cannot be obtained is partially present in the conversion efficiency map MP1.

For example, it can be seen that wavelength conversion efficiency is not high in a lower right region of the conversion efficiency map MP regardless of the temperature of the nonlinear optical crystal 30. This phenomenon is sometimes reproduced even if the nonlinear optical crystal 30 is replaced with another one. Therefore, there is a possibility that the wavelength conversion efficiency does not depend on the quality of the nonlinear optical crystal 30. Thus, as a result of detailed examination, the inventor found that the wavelength conversion efficiency depends on the shape of the nonlinear optical crystal 30. The inventor found that there is a possibility that the nonlinear optical crystal 30 has a large difference in a temperature distribution in a direction parallel to the optical axis of the nonlinear optical crystal 30 and cannot maintain complete phase matching in an entire light traveling direction. In the related art, it is difficult to grasp such a fact and there is a deficiency that a region where output of output light cannot be sufficiency obtained is set as a usable region.

FIG. 13 is a diagram illustrating a route RT including the incident position determined by the incident position determining means 102 in the information processing apparatus 100 in the wavelength conversion system 1 according to the first embodiment. As illustrated in FIG. 13, the incident position determining means 102 specifies, based on the conversion efficiency maps MP under the selected two or more temperature conditions, maximum wavelength conversion efficiency among wavelength conversion efficiencies under a plurality of temperature conditions for the respective coordinates in coordinates of a plurality of input positions IP. The incident position determining means 102 specifies a coordinate where the maximum conversion efficiency is equal to or larger than a predetermined threshold. Since the coordinate where the maximum conversion efficiency is equal to or larger than the predetermined threshold is also referred to as matching coordinate because the coordinate has the maximum conversion efficiency equal to or larger than the predetermined threshold. In this way, the incident position determining means 102 may determine an incident position from the matching coordinate.

Specifically, the incident position determining means 102 specifies maximum conversion efficiency for the input positions IP based on the conversion efficiency maps MP under five temperature conditions (temperatures of respectively −1.2° C., −0.6° C., ±0° C., +0.6° C., and +1.2° C. from a predetermined temperature). For example, maximum conversion efficiency of the input position IP1 is ≥50% and maximum conversion efficiency of the input position IP2 is ≥50%. Maximum conversion efficiency of the input position IP3 is also ≥50%. When the predetermined threshold is set to 50%, the incident position determining means 102 sets coordinates of the input position IP1, the input position IP2, the input position IP3, and the like where the maximum conversion efficiency is ≥50% as matching coordinates and determines an incident position from the matching coordinates.

The incident position determining means 102 may generate the route RT including only a plurality of matching coordinates. The incident position determining means 102 may determine an incident position from the matching coordinates in the route RT. Specifically, for example, when determining the next incident position after setting a first matching coordinate (the input position IP1) in the route RT as an incident position, the incident position determining means 102 determines, as the next incident position, a second matching coordinate (the input position IP3) that is a matching coordinate in the route RT and is adjacent to the first matching coordinate. The incident position determining means 102 subsequently repeats this determination.

As explained above, the incident position determining means 102 may generate the route RT leading to the input position IP1 to the input position IP2 where the maximum conversion efficiency is ≥50%. Therefore, the route RT includes a matching coordinate where the maximum conversion efficiency is equal to or larger than the predetermined threshold.

The incident position determining means 102 may specify, based on the conversion efficiency map MP, a reference temperature at which wavelength conversion efficiency in a predetermined reference coordinate is maximized. Specifically, for example, as illustrated in FIG. 9, the incident position determining means 102 may set a reference coordinate as a coordinate of the center portion of the reference plane 31 and specify, based on the conversion efficiency map MP, a reference temperature (a predetermined temperature) at which wavelength conversion efficiency of the center portion of the reference plane 31 is maximized. The incident position determining means 102 may determine an incident position based on the conversion efficiency map MP at the reference temperature and the conversion efficiency maps MP for temperatures (for example, −1.2° C., −0.6° C., +0.6° C., and +1.2° C.) different from the reference temperature by predetermined temperatures.

The lower sides in the conversion efficiency maps MP and MP1 are equivalent to the predetermined surface 32. Then, the route RT may include a plurality of first line segments RT10 in a direction along the predetermined surface 32 and a second line segment RT20 connecting the first line segments RT10. First line segments such as first line segments RT11, RT15, and RT19 in FIG. 13 are collectively referred to as first line segments RT10. The length of the first line segments RT10 may be larger than the length of the second line segment RT20.

Since the temperature adjusting means 50 is in contact with the predetermined surface 32 of the nonlinear optical crystal 30, the temperature of the nonlinear optical crystal 30 shows a distribution in which the temperature drops further away from the predetermined surface 32. Therefore, in coordinates in the first line segments RT10 in the direction along the predetermined surface 32, temperatures showing maximum conversion efficiency are substantially equal. That is, a temperature difference among the temperatures showing the maximum conversion efficiency of the coordinates in the first line segments RT10 in the direction along the predetermined surface 32 is small. For that reason, when an incident position is scanned along the first line segments RT10, even if temperature control for the nonlinear optical crystal 30 by the temperature adjusting means 50 is limited or with only a temperature change of a small amount, it is possible to obtain satisfactory conversion efficiency in the coordinates.

The route RT is generated to set, as a start point, a matching coordinate belonging to the first line segment RT11 closest to the predetermined surface 32 and set, as an end point, a matching coordinate belonging to the first line segment RT19 most distant from the predetermined surface 32. Alternatively, the route RT is generated to set, as a start point, a matching coordinate belonging to the first line segment RT19 most distant from the predetermined surface 32 and set, as an end point, a matching coordinate belonging to the first line segment RT11 closest to the predetermined surface 32. In this way, the incident position determining means 102 may determine an incident position such that the route RT is drawn with a single stroke. The incident position may move back and forth on the route RT or the route RT may be different between when the incident position moves away from the predetermined surface and when the incident position moves close to the predetermined surface.

The control means 103 controls the moving means 40, which moves the nonlinear optical crystal 30, such that input light is made incident on the incident position determined by the incident position determining means 102. Specifically, the control means 103 controls the moving means 40 via the driver 90 to thereby change, toward the incident position determined by the incident position determining means 102, a position where input light is made incident on the nonlinear optical crystal 30.

The control means 103 sets, as a target temperature, a temperature at which wavelength conversion efficiency in an incident position specified based on the conversion efficiency map MP is equal to or larger than the predetermined threshold and causes the temperature adjusting means 50 to adjust the temperature of the nonlinear optical crystal 30.

Specifically, as illustrated in FIG. 13, when the incident position is moved along the first line segment RT11, the control means 103 sets, as a target temperature, temperature (−1.2° C. from the predetermined temperature) at which wavelength conversion efficiency in the incident position along the first line segment RT11 is ≥50% and causes the temperature adjusting means 50 to adjust the temperature of the nonlinear optical crystal 30.

When the incident position is moved along the first line segment RT15, the control means 103 sets, as a target temperature, temperature (±0° C. from the predetermined temperature) at which wavelength conversion efficiency in an incident position along the first line segment RT15 is ≥50% and causes the temperature adjusting means 50 to adjust the temperature of the nonlinear optical crystal 30.

Further, when the incident position is moved along the first line segment RT19, the control means 103 sets, as a target temperature, temperature (+1.2° C. from the predetermined temperature) at which wavelength conversion efficiency in an incident position along the first line segment RT19 is ≥50% and causes the temperature adjusting means 50 to adjust the temperature of the nonlinear optical crystal 30.

The control means 103 may not always set the temperature at the time of acquisition of the conversion efficiency map MP as a target and may control, according to the movement of the incident position, the temperature adjusting means 50 as appropriate in a direction in which conversion efficiency rises. That is, the control means 103 may monitor wavelength conversion efficiency while moving the incident position onto the route RT and cause the temperature adjusting means 50 to adjust the temperature of the nonlinear optical crystal 30 such that the wavelength conversion efficiency is maximized. The control means 103 may control output of the laser light L11 and the laser light L12 at the time of acquisition of the conversion efficiency map MP. The control means 103 may control an input wavelength. Specifically, the control means 103 may control the light source 10 to thereby oscillate the laser light L11 and the laser light L12 having a predetermined wavelength. The control means 103 may control a resonator length of the resonator 23 that performs sum wavelength mixing. Specifically, the control means 103 controls the resonator length control apparatus 80 to thereby control the resonator length of the resonator 23.

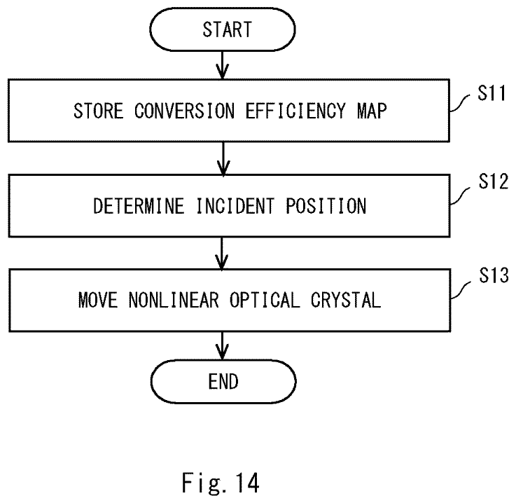

Subsequently, a wavelength conversion method using the wavelength conversion system 1 in the present embodiment is explained. FIG. 14 is a flowchart illustrating a wavelength conversion method using the wavelength conversion system 1 according to the first embodiment.

As illustrated in step S11 in FIG. 14, the control means 103 causes the storage means 101 to store the conversion efficiency map MP. For example, the control means 103 causes the storage means 101 to store the conversion efficiency map MP on the reference plane 31 of the nonlinear optical crystal 30, the conversion efficiency map MP being for each of a plurality of temperature conditions of the nonlinear optical crystal 30. Note that the conversion efficiency map MP may be created in the wavelength conversion system 1.

Subsequently, as illustrated in step S12, the control means 103 causes the incident position determining means 102 to determine an incident position. Specifically, the control means 103 causes the incident position determining means 102 to determine, based on the conversion efficiency maps MP under two or more temperature conditions selected from the storage means 101, an incident position where input light is made incident on the nonlinear optical crystal 30. For example, the incident position determining means 102 specifies, based on the conversion efficiency maps MP under the selected two or more temperature conditions, a matching coordinate of a coordinate of the input position IP where wavelength conversion efficiency is equal to or larger than a predetermined threshold and determine an incident position from the matching coordinate.

The incident position determining means 102 may specify, based on the conversion efficiency map MP, maximum conversion efficiency for coordinates and determine an incident position from a matching coordinate where the maximum conversion efficiency is equal to or larger than the predetermined threshold. Further, the incident position determining means 102 may generate the route RT including only a plurality of matching coordinates and determine an incident position from the matching coordinates in the route RT.

Subsequently, as illustrated in step S13, the control means 103 causes the moving means 40 to move the nonlinear optical crystal 30. Specifically, the control means 103 causes the moving means 40 to move the nonlinear optical crystal 30 such that input light is made incident on the determined incident position. In this way, the wavelength conversion system 1 can output output light obtained by converting a wavelength of the input light.

Subsequently, effects of the present embodiment are explained. In the wavelength conversion system 1 in the present embodiment, the incident position determining means 102 determines, based on the conversion efficiency map MP, an incident position where input light is made incident on the nonlinear optical crystal 30. Accordingly, the wavelength conversion system 1 makes the input light incident on an incident position where wavelength conversion efficiency is appropriate. Thus, it is possible to improve stability of output light.

As an example, the wavelength conversion system 1 in the present embodiment uses a CLBO crystal that generates ultraviolet light having a wavelength of 193 nm through sum frequency generation. The wavelength conversion system 1 measures, in advance, for a plurality of temperatures, wavelength conversion efficiency of the CLBO crystal across the reference plane 31. Thus, the wavelength conversion system 1 moves an incident position where input light is made incident on the CLBO crystal while controlling temperature along a region where wavelength conversion efficiency is high on the reference plane 31. Since the conversion efficiency map MP is based on the wavelength conversion efficiency, the conversion efficiency map MP is generated as a result taking into account all causes affecting the wavelength conversion efficiency such as light absorption in the nonlinear optical crystal 30, nonuniformity of a refractive index, and temperature nonuniformity of the nonlinear optical crystal 30. Thus, the wavelength conversion system 1 enables generation of light having a wavelength of 193 nm of high output stable for a long period.

As explained above, according to the present disclosure, by appropriately controlling the temperature of the nonlinear optical crystal 30 at the time when input light passes, it is possible to set an incident position in a moving region where necessary wavelength conversion efficiency can be obtained. Accordingly, with one nonlinear optical crystal 30, it is possible to increase a time in which deep ultraviolet light is generated without interruption.

For example, when 193 nm ultraviolet light is generated at an output of 100 mW, if 100 nm can be ensured as a total of moving distances when moving speed of an incident position is approximately 10 μm per hour and an output decrease of output light is less than 5%, continuous use for 10,000 hours is possible. This can be implemented by, for example, using a 50% or more region in a crystal having a cross section of 8×8 mm². For example, when a cross section of a nonlinear optical crystal is divided into 50×40=2000 measurement points and a conversion efficiency map MP at a certain temperature is acquired, it is sufficient that a measurement time at the measurement points is two seconds. That is, one conversion efficiency map MP can be acquired at approximately 4000 seconds (=67 minutes). When a temperature condition is changed in five ways, assuming that five minutes are required for temperature adjustment, all conversion efficiency maps MP can be acquired in 67×5+5×4=355 minutes, that is, approximately six hours.

As explained above, according to the present disclosure, it is possible to utilize, at the maximum, a CLBO crystal that is a key component in a light source having a wavelength of 193 nm usable in a semiconductor inspection apparatus or the like required to operate for 24 hours in 365 days. It is possible to construct the wavelength conversion system 1 having high reliability.

The embodiment of the present disclosure is explained above. However, the present disclosure includes appropriate modifications that do not spoil the objects and the advantages of the present disclosure and is not limited by the embodiment explained above. Configurations obtained by omitting and combining the configurations of the first embodiment as appropriate are also within the scope of the technical idea of the present disclosure. Configurations explained below are also within the scope of the technical idea of the embodiment.

It is also possible to realize one of the above wavelength conversion apparatus by causing a computer to execute any processes by using a computer program. Any processing may be realized by causing a computer including at least one processor to execute a program stored in a memory. For example, at least one of the incident position determining mean, the control mean, and the processing mean can be realized by a computer such as a dedicated computer or a personal computer (PC). The computer does not have to be a single physical computer, and may be multiple computers when performing distributed processing. The storage mean can be various storage devices such as a hard disk, a solid state disk, or an external storage device connected with the incident position determining mean.

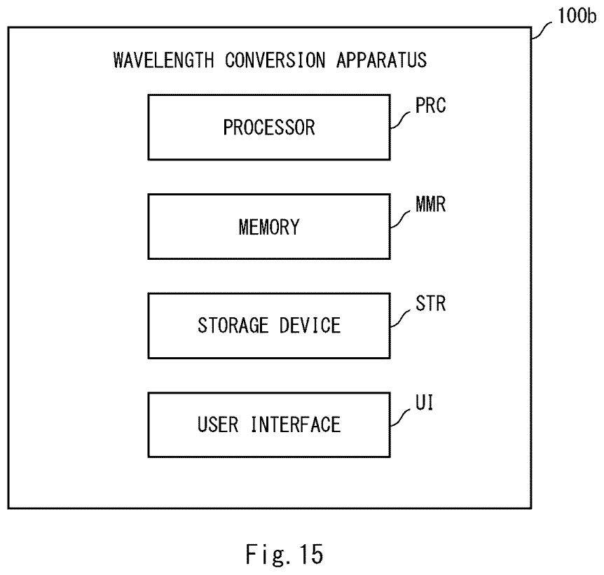

For example, the wavelength conversion apparatus described above may be, for example, an information processing device such as a server or a personal computer. FIG. 15 is a block diagram illustrating a wavelength conversion apparatus 100b in the wavelength conversion system according to the first embodiment. As illustrated in FIG. 15, the wavelength conversion apparatus 100b may further include a processor PRC, a memory MMR, a storage device STR, and a user interface UI. The storage device STR stores, as a program, processing to be executed by each configuration of the wavelength conversion apparatus 100b. Also, the processor PRC reads the program from the storage device STR to the memory MMR and executes the program. In this manner, the processor PRC realizes the functions of each configuration in the wavelength conversion apparatus 100b, such as the storage means 101, incident position determining means 102, and control means 103. The user interface UI may include input devices such as a keyboard, a mouse, and an image capturing device and output devices such as a display, a printer, and a speaker.

Each configuration included in the wavelength conversion apparatus 100b may be realized by dedicated hardware. In addition, some or all of the components may be realized by general-purpose or dedicated circuitries, the processor PRC, or the like, or a combination thereof. These may be configured of a single chip or may be configured of a plurality of chips connected via a bus. Some or all of the components may be realized by a combination of the aforementioned circuitries or the like and the program. Furthermore, a central processing unit (CPU), a graphics processing unit (GPU), a field-programmable gate array (FPGA), a quantum processor (quantum computer control chip), or the like can be used as the processor PRC.

Also, in a case where some or all of the components of the wavelength conversion apparatus 100b is realized by a plurality of wavelength conversion apparatus 100b, circuitries, and the like, the plurality of wavelength conversion apparatus 100b, circuitries, and the like may be arranged in a centralized manner or in a distributed manner. For example, the wavelength conversion apparatus, the circuitries, and the like may be realized in a form in which a client server system, a cloud computing system, or the like connects them via a communication network. Also, the functions of the wavelength conversion apparatus 100b may be provided in the form of software as a service (Saas).

### (Supplementary Note 1)

A wavelength conversion method comprising:
a step of causing storage means to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal;
a step of causing incident position determining means to determine, based on the conversion efficiency maps under two or more of the temperature conditions selected from the storage means, an incident position where the input light is made incident on the nonlinear optical crystal; and
a step of causing moving means to move relative positions of the nonlinear optical crystal and the input light such that the input light is made incident on the determined incident position.

### (Supplementary Note 2)

The wavelength conversion method described in the supplementary note 1, in which
in the step of causing the incident position determining means to determine the incident position,
the incident position determining means:
specifies, based on the conversion efficiency maps under the selected two or more temperature conditions, at least one matching coordinate that is a coordinate of the input position where the wavelength conversion efficiency in at least one of the temperature conditions is equal to or larger than a predetermined threshold; and
determines the incident position from the at least one matching coordinate.

### (Supplementary Note 3)

The wavelength conversion method described in the supplementary note 1, in which
in the step of causing the incident position determining means to determine the incident position,
the incident position determining means:
specifies, based on the conversion efficiency maps under the selected two or more temperature conditions, maximum conversion efficiency that is a largest one of the wavelength conversion efficiencies under the plurality of temperature conditions for respective coordinates in coordinates of the plurality of input positions;
specifies at least one matching coordinate that is a coordinate of the input position where the maximum conversion efficiency is equal to or larger than a predetermined threshold; and
determines the incident position from the at least one matching coordinate.

### (Supplementary Note 4)

The wavelength conversion method described in the supplementary note 1, in which
in the step of causing the incident position determining means to determine the incident position,
the incident position determining means:
specifies, based on the conversion efficiency maps under the selected two or more temperature conditions, at least one matching coordinate that is a coordinate of the input position where the wavelength conversion efficiencies under the plurality of temperature conditions are equal to or larger than a predetermined threshold; and
determines the incident position from the at least one matching coordinate.

### (Supplementary Note 5)

The wavelength conversion method described in any one of the supplementary notes 2 to 4, in which
in the step of causing the incident position determining means to determine the incident position,
the incident position determining means:
generates a route including only a plurality of the matching coordinates; and
determines the incident position from the matching coordinates in the route.

### (Supplementary Note 6)

The wavelength conversion method described in the supplementary note 5, in which
in the step of causing the incident position determining means to determine the incident position,
after determining a first matching coordinate in the route as the incident position, when determining a next incident position of the incident position, the incident position determining means determines, as the next incident position, a second matching coordinate that is the at least one matching coordinate in the route and is adjacent to the first matching coordinate and subsequently repeats this determination.

### (Supplementary Note 7)

The wavelength conversion method described in the supplementary note 6, in which
in the step of causing the incident position determining means to determine the incident position,
the incident position determining means determines the incident position such that the route is drawn with a single stroke.

### (Supplementary Note 8)

The wavelength conversion method described in the supplementary note 5, in which
the nonlinear optical crystal is in contact with temperature adjusting means for performing temperature adjustment for a nonlinear optical crystal on a predetermined surface side,
the route includes a plurality of first line segments in a direction along the predetermined surface and a second line segment connecting the first line segments, and
a length of the first line segments is larger than a length of the second line segment.

### (Supplementary Note 9)

The wavelength conversion method described in the supplementary note 8, in which the route is generated to set, as a start point, the at least one matching coordinate belonging to the first line segment closest to the predetermined surface and set, as an end point, the at least one matching coordinate belonging to the first line segment most distant from the predetermined surface, or is generated to set, as a start point, the at least one matching coordinate belonging to the first line segment most distant from the predetermined surface and set, as an end point, the at least one matching coordinate belonging to the first line segment closest to the predetermined surface.

### (Supplementary Note 10)

The wavelength conversion method described in the supplementary note 1, in which
the nonlinear optical crystal is in contact with temperature adjusting means for performing temperature adjustment for the nonlinear optical crystal on a predetermined surface side, and
the wavelength conversion method further comprises a step of setting, as a target temperature, a temperature at which the wavelength conversion efficiency in the incident position specified based on the at least one conversion efficiency map is equal to or larger than a predetermined threshold and causing the temperature adjusting means to adjust the temperature of the nonlinear optical crystal.

### (Supplementary Note 11)

The wavelength conversion method described in the supplementary note 1, further comprising a step of monitoring the wavelength conversion efficiency while moving the incident position onto a route and causing temperature adjusting means to adjust a temperature of the nonlinear optical crystal such that the wavelength conversion efficiency is maximized.

### (Supplementary Note 12)

The wavelength conversion method described in the supplementary note 10, in which the predetermined surface includes one to four surfaces among surfaces excluding an incident surface of the input light and an output surface of the output light of the nonlinear optical crystal.

### (Supplementary Note 13)

The wavelength conversion method described in the supplementary note 10, in which
the predetermined surface is one surface among surfaces excluding an incident surface of the input light and an output surface of the output light of the nonlinear optical crystal, and
the nonlinear optical crystal is in contact with a holding member, a position of which is changed by the moving means, on the surface side excluding the incident surface and the output surface.

### (Supplementary Note 14)

The wavelength conversion method described in the supplementary note 1, in which a temperature difference between temperatures under adjacent temperature conditions corresponding to a selected plurality of the conversion efficiency maps is smaller than a temperature phase matching allowable width of the nonlinear optical crystal.

### (Supplementary Note 15)

The wavelength conversion method described in the supplementary note 1, in which a temperature difference between temperatures under adjacent temperature conditions corresponding to a selected plurality of the conversion efficiency maps is equal to or smaller than a half of a temperature phase matching allowable width of the nonlinear optical crystal.

### (Supplementary Note 16)

The wavelength conversion method described in the supplementary note 15, in which
in the step of causing the incident position determining means to determine the incident position,
the incident position determining means:
specifies, based on the at least one conversion efficiency map, a reference temperature at which the wavelength conversion efficiency in a predetermined reference coordinate is maximized; and
determines the incident position based on the at least one conversion efficiency map at the reference temperature and the at least one conversion efficiency map for a temperature different from the reference temperature by a predetermined temperature.

### (Supplementary Note 17)

The wavelength conversion method described in the supplementary note 1, in which
the input light includes light in an ultraviolet region and light in an infrared region, and
the nonlinear optical crystal converts a wavelength through sum frequency mixing of the light in the ultraviolet region and the light in the infrared region.

### (Supplementary Note 18)

The wavelength conversion method described in the supplementary note 1, further comprising a step of generating the at least one conversion efficiency map under a plurality of temperature conditions and recording the at least one conversion efficiency map in the storage means.

### (Supplementary Note 19)

A wavelength conversion apparatus comprising:
storage unit configured to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal;
hardware processor; and
memory storing one or more programs configured to be executed by the hardware processor, the one or more programs including instructions for:
determining, based on the conversion efficiency maps under two or more of the temperature conditions selected from the storage unit, an incident position where the input light is made incident on the nonlinear optical crystal; and
controlling a moving unit configured to move relative positions of the nonlinear optical crystal and the input light, such that the input light is made incident on the determined incident position.
   From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A wavelength conversion apparatus comprising:
storage unit configured to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal;
incident position determining unit configured to determine, based on the conversion efficiency maps under two or more of the temperature conditions selected from the storage unit, an incident position where the input light is made incident on the nonlinear optical crystal; and
control unit configured to control, such that the input light is made incident on the incident position determined by the incident position determining unit, moving unit configured to move relative positions of the nonlinear optical crystal and the input light.

2. The wavelength conversion apparatus according to claim 1, wherein
the incident position determining unit:
specifies, based on the conversion efficiency maps under the selected two or more temperature conditions, at least one matching coordinate that is a coordinate of the input position where the wavelength conversion efficiency in at least one of the temperature conditions is equal to or larger than a predetermined threshold; and
determines the incident position from the at least one matching coordinate.

3. The wavelength conversion apparatus according to claim 1, wherein
the incident position determining unit:
specifies, based on the conversion efficiency maps under the selected two or more temperature conditions, maximum conversion efficiency that is a largest one of the wavelength conversion efficiencies under the plurality of temperature conditions for respective coordinates in coordinates of the plurality of input positions;
specifies at least one matching coordinate that is a coordinate of the input position where the maximum conversion efficiency is equal to or larger than a predetermined threshold; and
determines the incident position from the at least one matching coordinate.

4. The wavelength conversion apparatus according to claim 1, wherein
the incident position determining unit:
specifies, based on the conversion efficiency maps under the selected two or more temperature conditions, at least one matching coordinate that is a coordinate of the input position where the wavelength conversion efficiencies under the plurality of temperature conditions are equal to or larger than a predetermined threshold; and
determines the incident position from the at least one matching coordinate.

5. The wavelength conversion apparatus according to claim 2, wherein
the incident position determining unit:
generates a route including only a plurality of the matching coordinates; and
determines the incident position from the matching coordinates in the route.

6. The wavelength conversion apparatus according to claim 5, wherein
after determining a first matching coordinate in the route as the incident position, when determining a next incident position of the incident position, the incident position determining unit determines, as the next incident position, a second matching coordinate that is the at least one matching coordinate in the route and is adjacent to the first matching coordinate and subsequently repeats this determination.

7. The wavelength conversion apparatus according to claim 6, wherein the incident position determining unit determines the incident position such that the route is drawn with a single stroke.

8. The wavelength conversion apparatus according to claim 5, wherein
the nonlinear optical crystal is in contact with temperature adjusting unit configured to perform temperature adjustment for a nonlinear optical crystal on a predetermined surface side,
the route includes a plurality of first line segments in a direction along the predetermined surface and a second line segment connecting the first line segments, and
a length of the first line segments is larger than a length of the second line segment.

9. The wavelength conversion apparatus according to claim 8, wherein the route is generated to set, as a start point, the at least one matching coordinate belonging to the first line segment closest to the predetermined surface and set, as an end point, the at least one matching coordinate belonging to the first line segment most distant from the predetermined surface, or is generated to set, as a start point, the at least one matching coordinate belonging to the first line segment most distant from the predetermined surface and set, as an end point, the at least one matching coordinate belonging to the first line segment closest to the predetermined surface.

10. The wavelength conversion apparatus according to claim 1, wherein
the nonlinear optical crystal is in contact with temperature adjusting unit configured to perform temperature adjustment for the nonlinear optical crystal on a predetermined surface side, and
the control unit sets, as a target temperature, a temperature at which the wavelength conversion efficiency in the incident position specified based on the at least one conversion efficiency map is equal to or larger than a predetermined threshold and causes the temperature adjusting unit to adjust the temperature of the nonlinear optical crystal.

11. The wavelength conversion apparatus according to claim 1, wherein the control unit monitors the wavelength conversion efficiency while moving the incident position onto a route and causes temperature adjusting unit to adjust a temperature of the nonlinear optical crystal such that the wavelength conversion efficiency is maximized.

12. The wavelength conversion apparatus according to claim 10, wherein the predetermined surface includes one to four surfaces among surfaces excluding an incident surface of the input light and an output surface of the output light of the nonlinear optical crystal.

13. The wavelength conversion apparatus according to claim 10, wherein
the predetermined surface is one surface among surfaces excluding an incident surface of the input light and an output surface of the output light of the nonlinear optical crystal, and
the nonlinear optical crystal is in contact with a holding member, a position of which is changed by the moving unit, on the surface side excluding the incident surface and the output surface.

14. The wavelength conversion apparatus according to claim 1, wherein a temperature difference between temperatures under adjacent temperature conditions corresponding to a selected plurality of the conversion efficiency maps is smaller than a temperature phase matching allowable width of the nonlinear optical crystal.

15. The wavelength conversion apparatus according to claim 1, wherein a temperature difference between temperatures under adjacent temperature conditions corresponding to a selected plurality of the conversion efficiency maps is equal to or smaller than a half of a temperature phase matching allowable width of the nonlinear optical crystal.

16. The wavelength conversion apparatus according to claim 15, wherein
the incident position determining unit:
specifies, based on the at least one conversion efficiency map, a reference temperature at which the wavelength conversion efficiency in a predetermined reference coordinate is maximized; and
determines the incident position based on the at least one conversion efficiency map at the reference temperature and the at least one conversion efficiency map for a temperature different from the reference temperature by a predetermined temperature.

17. The wavelength conversion apparatus according to claim 1, wherein
the input light includes light in an ultraviolet region and light in an infrared region, and
the nonlinear optical crystal converts a wavelength through sum frequency mixing of the light in the ultraviolet region and the light in the infrared region.

18. The wavelength conversion apparatus according to claim 1, wherein the wavelength conversion apparatus generates the at least one conversion efficiency map under a plurality of temperature conditions and records the at least one conversion efficiency map in the storage unit.

19. A wavelength conversion method comprising:
a step of causing storage unit to store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal;
a step of causing incident position determining unit to determine, based on the conversion efficiency maps under two or more of the temperature conditions selected from the storage unit, an incident position where the input light is made incident on the nonlinear optical crystal; and
a step of causing moving unit to move relative positions of the nonlinear optical crystal and the input light such that the input light is made incident on the determined incident position.

20. A wavelength conversion apparatus comprising:
at least one memory storing instructions, and
at least one processor configured to execute the instructions to:
store at least one conversion efficiency map in which wavelength conversion efficiency for each of a plurality of input positions of input light on a reference plane of a nonlinear optical crystal that converts a wavelength of output light from a wavelength of the input light is stored in association with the input position, the at least one conversion efficiency map being for each of a plurality of temperature conditions of the nonlinear optical crystal;
determine, based on the conversion efficiency maps under two or more of the temperature conditions selected from the storage unit, an incident position where the input light is made incident on the nonlinear optical crystal; and
control, such that the input light is made incident on the determined incident position, moving unit configured to move relative positions of the nonlinear optical crystal and the input light.
